(19) United States
(12) Patent Application Publication
(10) Pub. No.: US 2014/0051572 A1
(43) Pub. Date: Feb. 20, 2014

(54) SYNERGISTIC INSECTICIDAL COMPOSITIONS

(71) Applicant: DOW AGROSCIENCES LLC, Indianapolis, IN (US)

(72) Inventors: Maria S. Grigera, Buenos Aires (AR); Maria E. Cometti, Buenos Aires (AR); Carlos N. Vassallo, Buenos Aires (AR)

(73) Assignee: DOW AGROSCIENCES LLC, Indianapolis, IN (US)

(21) Appl. No.: 13/962,312

(22) Filed: Aug. 8, 2013

Related U.S. Application Data
(60) Provisional application No. 61/684,491, filed on Aug. 17, 2012.

(51) Int. Cl. A01N 43/88; A01N 37/46; A01N 43/30; A01N 43/22

(52) U.S. Cl. CPC A01N 43/88; A01N 43/22; A01N 37/46; A01N 43/30
USPC 504/100; 514/28

(57) ABSTRACT

A synergistic pesticidal composition including a Spinosyn and thiamethoxam is used to control cutworms. A seed treatment composition including a Spinosyn and thiamethoxam is used to make coated seeds that exhibit synergy in the control of cutworms. In various aspects, the invention relates to pesticidal compositions, seed treatment compositions, methods of controlling cutworms, methods of treating seeds, and coated seeds produced thereby.

### CROSS-REFERENCE TO RELATED APPLICATION

The present application claims priority to U.S. Provisional Patent Application No. 61/684,491 filed Aug. 17, 2012, the content of which is incorporated herein by reference in its entirety.

### BACKGROUND

The control of insects and related arthropods is of extreme importance to the agricultural industry. Insects and related arthropods annually destroy an estimated 15% of agricultural crops in the United States and even more than that in developing countries. Some of this damage occurs when plant pathogens, insects and other such soil borne pests damage a seedling. The period during germination of the seed, sprouting and initial growth of the plant is particularly critical because the roots and shoots of the growing plant are small and even a small amount of damage can kill the entire plant. Moreover, some natural plant defenses are not fully developed at this stage and the plant is vulnerable to attack.

Much damage to seedlings is caused by cutworms, which are insect pests that feed upon or otherwise damage stems of seedlings, and other pests that feed upon or damage parts of the plant. As used herein, the term “cutworm” refers to any species of insect whose larvae feed on the stems of plants, which often results in a plant falling to the ground due to the damage to its stem. Cutworms commonly are larvae of moths, and their typical behavior is to hide under litter or soil during the day and come out in the dark to feed on plants. While some cutworms remain with a plant is has cut down and feed on the felled plant, others often move on to another seedling standing nearby after eating only a small amount from a felled seedling, which causes disproportionate damage to crops. Many cutworm species are in Family Noctuidae and Genus Agrotis; however, the name is based on a feeding behavior rather than physiological characteristics, and other cutworm species exist that are classified in other Families and/or other Genera.

Larvae of species Agrotis malefida (Guénée), a geographically spread moth, are cutworms that cause a substantial amount of agricultural damage, and are of particular concern in the Southern Cone of South America, particularly in the Rolling Pampas, Argentina. The distribution of this cutworm is ubiquitous, and the spectrum of crops that it attacks is broad. The larvae typically become active at dusk, feeding on seedlings and causing a reduction in plant stand. A. malefida larvae have been observed to feed on, for example, sunflower, corn, alfalfa, tomato, tobacco, soybeans, some weeds and other plant species.

An increase in cutworm damage has been observed to be coincident with the increasing use of no-till planting techniques in recent decades. This increase in cutworm damage has led to the use of insecticides, which are typically applied only when the number of cutworm larvae in a given area is above a tolerable level of infestation (i.e., larvae density), which can be determined, for example, by determining the number of cutworms in a given locus using toxic traps or by observing the amount of damage caused by cutworms in the area. For sunflower crops, whose seedlings are a target of A. malefida larvae and also other species of cutworm, the economic threshold for applying an insecticide is typically considered to be about 3 to 5% of cut plants and/or about 2 to 3 larvae per 100 plants. While substantial attention has been given to the control of A. malefida and other cutworm species, and thus reduction of the damage caused by these insects, further advancements are needed. The present disclosure addresses this need and provides additional benefits.

### SUMMARY

The present invention relates to methods, compositions and materials for improving the growing characteristics of a plant, in particular by protecting the plant in its seedling stage against damage by cutworms. More particularly, the present disclosure concerns the discovery of a synergistic effect exhibited by a pesticide mixture comprising a Spinosyn and thiamethoxam. It has been discovered that the pesticide mixture has a synergistic effect in controlling cutworms, i.e., a Spinosyn and thiamethoxam have been shown to be more effective in combination than would be expected based on their effect individually. The term “synergistic” is used herein to refer to an interaction of two or more factors such that the effect when combined is greater than the predicted effect based on the response to each factor applied separately. The present disclosure relates to the discovery that a Spinosyn and thiamethoxam, already known individually to have insecticidal efficacy, display a synergistic insecticidal effect in controlling cutworms when applied in combination.

In one aspect, therefore, the present disclosure provides pesticides comprising a synergistic combination of pesticidal compounds. As used herein, the term “pesticidal compound” is used to refer to a compound that has the purpose or effect of preventing or reducing damage to a plant caused by any pest or of repelling, deterring or destroying the pest. A compound that kills, controls or otherwise adversely affects the growth of an individual insect or a population of an insect species is a pesticidal compound. The term “pesticide” is used herein to mean a composition, formulation, mixture or other material that includes at least one pesticidal compound.

The present disclosure also concerns the discovery that treating seeds before they are sown or planted with a combination of a Spinosyn and thiamethoxam provides surprisingly effective control of cutworms and an increase in crop stand. Thus, in one aspect, the present disclosure relates to the use of a Spinosyn and thiamethoxam together as a seed treatment. The term “seed treatment” generally refers to application of a material to a seed prior to or during the time it is planted in soil. Seed treatment with pesticides has the advantages of delivering pesticides to the locus at which the seeds are planted shortly before germination of the seed and emergence of a seedling. In addition to the synergistic effect of the this combination of pesticides, delivery of the pesticides by seed treatment has the advantage of administering the pesticides directly to the locus of the emerging seedling, which minimizes the amount of pesticide that is required and limits the amount of contact of workers with the pesticide compared to application techniques such as spraying over soil or over emerging seedlings themselves. Moreover, because cutworm damage is typically done within the early stages of plant life, i.e., within the first thirty days following emergence of the seedling, delivery of an anti-cutworm pesticide as a seed treatment places the pesticide at the locus of action at the most critical time for its activity.

Accordingly, the present disclosure relates to pesticidal compositions for and methods of controlling undesirable pests, the compositions including a Spinosyn and thiamethoxam. In various aspects, the disclosure provides the synergistic pesticidal compositions themselves and methods for making and using the compositions, including, for example, methods for making and using seed treatment compositions that includes the synergistic combination and seeds treated thereby. As used herein, the term “seed treatment composition” refers to the slurry that is actually applied to seeds in a seed treatment process.

Further embodiments, forms, features, advantages, aspects, and benefits shall become apparent from the following descriptions.

### BRIEF DESCRIPTION OF THE FIGURES

FIG. 1 is a box plot illustrating results of field tests described in the Examples at day 3 after infestation with cutworms.

FIG. 2 is a box plot illustrating results of field tests described in the Examples at day 5 after infestation with cutworms.

FIG. 3 is a box plot illustrating results of field tests described in the Examples at day 10 after infestation with cutworms.

### DETAILED DESCRIPTION

For the purpose of promoting an understanding of the principles of the invention, reference will now be made to various embodiments and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

The combinations of this disclosure demonstrate synergistically enhanced action resulting in, for example, reduced damage to the plant by cutworms and higher crop yields. The increase in advantageous properties achieved with the combinations are significantly greater than the activity to be expected by the individual components. In particular, it has been found, surprisingly, that the activity of the treatment of the combinations, compared with the activity of the individual active ingredients, are not merely additive, as may essentially be expected, but that a synergistic effect exists.

In a first aspect, the present disclosure provides a synergistic pesticidal composition (also referred to herein as a “synergistic mixture”) that is effective to control cutworms. The pesticidal composition is thereby operable to improve the production of a crop in an area infested with cutworms or prophylactically protect a crop from potential infestation by cutworms. The pesticidal composition comprises a Spinosyn and thiamethoxam. The pesticidal composition optionally can also include one or more of the following additional ingredients: one or more additional pesticides, one or more herbicides, one or more other active ingredients and one or more auxiliary ingredient.

The term “Spinosyn” is used in this document to refer to the naturally occurring compounds isolated from the fermentation products of Saccharopolyspora spinosa bacteria that are commonly identified by this name and synthetically produced analogs or derivatives thereof. Examples of Spinosyns include Spinosad, which is a racemic mixture of Spinosyn A and Spinosyn D, and Spinetoram, which is a synthetically produced derivative, as disclosed in U.S. Pat. Nos. 5,227,295; 5,670,364; 5,591,606; 6,001,981; 6,143,526; 6,455,504; 6,585,990; 6,919,464; 5,362,634; 5,539,089; and 5,202,242, each of which is hereby incorporated herein by reference in its entirety. In certain embodiments, the Spinosyn is or comprises Spinosad, which is a racemic mixture of Spinosyn A, which has the following structure:

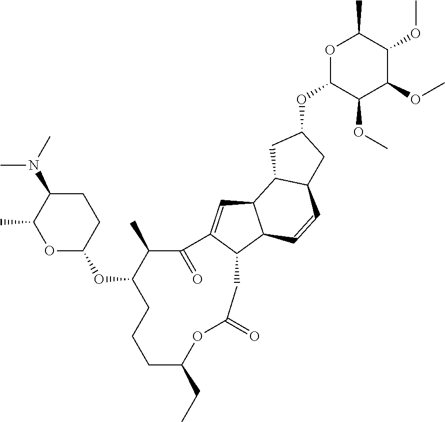

and Spinosyn D, which has the following structure:

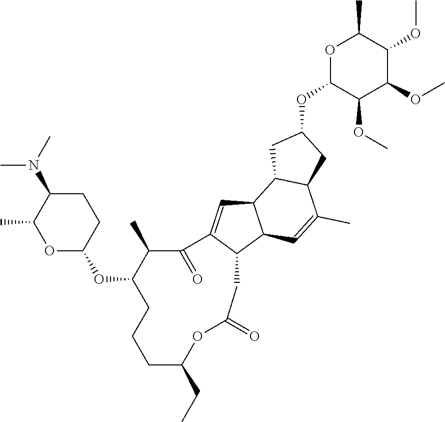

in an approximately 17:3 ratio.

The term “thiamethoxam” is used herein to refer to a compound in the class of neonicotinoids that has the following structure:

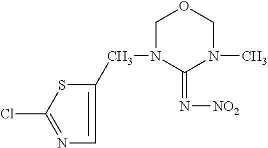 [SMILES: CN1COCN(Cc2cnc(Cl)s2)/C1=N/[N+](=O)[O-]]

Pesticidal activity is exhibited by the compounds of the synergistic mixture when they are applied directly to a cutworm, or to a locus inhabited or visited by the cutworm or to a plant in said locus. In some embodiments, the synergistic mixture is applied to a seedling, or to a locus of a seedling, to be protected from cutworms. In some embodiments, the synergistic mixture is applied to seeds prior to or at the time of planting. The pesticidal effect observed following application of the synergistic mixture can depend upon multiple factors, including, for example, the cutworm species to be controlled, the stage of growth of the plant, the application parameters of dilution (when the synergistic mixture is applied as a liquid), the particle size of solid components (when the synergistic mixture is applied as a solid), the environmental conditions at the time of use, the specific compound employed, the specific adjuvants and carriers employed, the soil type, and the like, as well as the amount of pesticide applied. Adjustment of these and other factors is within the purview of a person of ordinary skill in the art having the benefit of the present disclosure.

The Spinosyn and the thiamethoxam are present in the pesticidal composition in synergistically effective amounts. The ratio of the Spinosyn and the thiamethoxam, and the total amount of the mixture, depends on many factors, including the type and the occurrence of the cutworms to be controlled. For each application, the optimum ratios and total amounts to be employed can in each case be determined by routine experimentation. In one embodiment, the weight ratio of the Spinosyn to the thiamethoxam in the composition is within the range of between about 1:150 and about 75:1 or any range that is a subset within said range. In yet another embodiment, the ratio by weight between the Spinosyn and the thiamethoxam is in the range of 1:75 to 40:1. In still another embodiment, the ratio by weight between the Spinosyn or a formulation including the Spinosyn and the thiamethoxam is in the range of 1:15 to 10:1. In still yet another embodiment, the ratio by weight between the Spinosyn or a formulation including the Spinosyn and the thiamethoxam is in the range of 1:2 to 1:1. However, it should be understood that alternative values for the ratio by weight between the Spinosyn and the thiamethoxam are possible.

A pesticide comprising a synergistic combination of a Spinosyn and thiamethoxam, with or without one or more additional pesticidal compounds, can be delivered to a locus in a wide variety of manners and in a wide variety of formulations. For example, the pesticidal compounds can be mixed with a liquid carrier to provide a liquid formulation that is delivered to a locus as a liquid, or can be mixed with a solid carrier to provide a solid formulation that is delivered to a locus as a solid. Moreover, a liquid formulation can be delivered by spraying or otherwise applying the formulation to soil, for example before planting of crop seeds, at the same time as planting, after planting but prior to emergence of a seedling, or after emergence of a seedling. A solid formulation also can be delivered to a locus, for example, prior to planting, during planting or after planting. In one embodiment, a formulation can be used to treat seeds or other plant propagation material prior to or at the same time as planting, as discussed further herein below, which results in delivery of the pesticide to a locus at the same time as seed planting.

Accordingly, in one embodiment a pesticide comprises a mixture including a pesticidally effective amount of the Spinosyn and the thiamethoxam along with at least one agriculturally acceptable adjuvant and/or carrier. A “pesticidally effective amount” is an amount of active ingredient or a combination of active ingredients that is effective to prevent or reduce damage to a plant caused by any pest or to repel, deter or destroy a pest or to cause an adverse effect to an individual insect or an insect population, including, for example, deviations from natural development, killing, regulation, and the like. Suitable adjuvants or carriers should not be phytotoxic to valuable crops, particularly at the concentrations employed in applying the compositions for cutworm control in the presence of crops, and should not react chemically with pesticidal components of the mixture or other composition ingredients. Such mixtures can be designed for application directly to seeds or to a field locus or can be concentrates or formulations that are normally diluted with additional carriers and/or adjuvants before application as described further herein below. Solid forms of the pesticide can be, for example, dusts, granules, water dispersible granules, or wettable powders. Liquid forms of the pesticide can be, for example, emulsifiable concentrates, solutions, emulsions or suspensions, as discussed further herein below.

Examples of suitable solid carriers include talc, pyrophyllite clay, silica, attapulgus clay, kaolin clay, kieselguhr, chalk, diatomaceous earth, lime, calcium carbonate, bentonite clay, Fuller's earth, cottonseed hulls, wheat flour, soybean flour, pumice, wood flour, walnut shell flour, lignin, and the like.

Liquid carriers that can be employed include water and organic solvents. Examples of suitable organic solvents include, but are not limited to, petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like. Examples of specific organic solvents include toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methyl alcohol, ethyl alcohol, isopropyl alcohol, amyl alcohol, ethylene glycol, propylene glycol, glycerine, N-methyl-2-pyrrolidinone, N,N-dimethyl alkylamides, dimethyl sulfoxide, liquid fertilizers and the like. Water is generally the carrier of choice for the dilution of concentrates.

In other embodiments, pesticidal compositions are provided that include additional pesticidal compounds in addition to the Spinosyn and thiamethoxam. Some of the additional pesticidal compounds that can be employed beneficially in combination with the compositions disclosed in this document include, but are not limited to the following:

1,2 dichloropropane, 1,3 dichloropropene,

abamectin, acephate, acequinocyl, acetamiprid, acethion, acetoprole, acrinathrin, acrylonitrile, alanycarb, aldicarb, aldoxycarb, aldrin, allethrin, allosamidin, allyxycarb, alpha cypermethrin, alpha ecdysone, amidithion, amidoflumet, aminocarb, amiton, amitraz, anabasine, arsenous oxide, athidathion, azadirachtin, azamethiphos, azinphos ethyl, azinphos methyl, azobenzene, azocyclotin, azothoate,

barium hexafluorosilicate, barthrin, benclothiaz, bendiocarb, benfuracarb, benomyl, benoxafos, bensultap, benzoximate, benzyl benzoate, beta cyfluthrin, beta cypermethrin, bifenazate, bifenthrin, binapacryl, bioallethrin, bioethanomethrin, biopermethrin, bistrifluoron, borax, boric acid, bromfenvinfos, bromo DDT, bromocyclen, bromophos, bromophos ethyl, bromopropylate, bufencarb, buprofezin, butacarb, butathiofos, butocarboxim, butonate, butoxycarboxim,

cadusafos, calcium arsenate, calcium polysulfide, camphechlor, carbanolate, carbaryl, carbofuran, carbon disulfide, carbon tetrachloride, carbophenothion, carbosulfan, cartap, chinomethionat, chlorantraniliprole, chlorbenside, chlorbicyclen, chlordane, chlordecone, chlordimeform, chlorethoxyfos, chlorfenapyr, chlorfenethol, chlorfenson, chlorfensulphide, chlorfenvinphos, chlorfluazuron, chlormephos, chlorobenzilate, chloroform, chloromebuform, chloromethiuron, chloropicrin, chloropropylate, chlorphoxim, chlorprazophos, chlorpyrifos, chlorpyrifos methyl, chlorthiophos, chromafenozide, cinerin I, cinerin II, cismethrin, cloethocarb, clofentezine, closantel, clothianidin, copper acetoarsenite, copper arsenate, copper naphthenate, copper oleate, coumaphos, coumithoate, crotamiton, crotoxyphos, cruentaren A&B, crufomate, cryolite, cyanofenphos, cyanophos, cyanthoate, cyclethrin, cycloprothrin, cyenopyrafen, cyflumetofen, cyfluthrin, cyhalothrin, cyhexatin, cypermethrin, cyphenothrin, cyromazine, cythioate,

d-limonene, dazomet, DBCP, DCIP, DDT, decarbofuran, deltamethrin, demephion, demephion O, demephion S, demeton, demeton methyl, demeton O, demeton O methyl, demeton S, demeton S methyl, demeton S methylsulphon, diafenthiuron, dialifos, diamidafos, diazinon, dicapthon, dichlofenthion, dichlofluanid, dichlorvos, dicofol, dicresyl, dicrotophos, dicyclanil, dieldrin, dienochlor, diflovidazin, diflubenzuron, dilor, dimefluthrin, dimefox, dimetan, dimethoate, dimethrin, dimethylvinphos, dimetilan, dinex, dinobuton, dinocap, dinocap 4, dinocap 6, dinocton, dinopenton, dinoprop, dinosam, dinosulfon, dinotefuran, dinoterbon, diofenolan, dioxabenzofos, dioxacarb, dioxathion, diphenyl sulfone, disulfuram, disulfoton, dithicrofos, DNOC, dofenapyn, doramectin,

ecdysterone, emamectin, EMPC, empenthrin, endosulfan, endothion, endrin, EPN, epofenonane, eprinomectin, esfenvalerate, etaphos, ethiofencarb, ethion, ethiprole, ethoate methyl, ethoprophos, ethyl DDD, ethyl formate, ethylene dibromide, ethylene dichloride, ethylene oxide, etofenprox, etoxazole, etrimfos, EXD,

famphur, fenamiphos, fenazaflor, fenazaquin, fenbutatin oxide, fenchlorphos, fenethacarb, fenfluthrin, fenitrothion, fenobucarb, fenothiocarb, fenoxacrim, fenoxycarb, fenpirithrin, fenpropathrin, fenpyroximate, fenson, fensulfothion, fenthion, fenthion ethyl, fentrifanil, fenvalerate, fipronil, flonicamid, fluacrypyrim, fluazuron, flubendiamide, flubenzimine, flucofuron, flucycloxuron, flucythrinate, fluenetil, flufenerim, flufenoxuron, flufenprox, flumethrin, fluorbenside, fluvalinate, fonofos, formetanate, formothion, formparanate, fosmethilan, fospirate, fosthiazate, fosthietan, fosthietan, furathiocarb, furethrin, furfural,

gamma cyhalothrin, gamma HCH,

halfenprox, halofenozide, HCH, HEOD, heptachlor, heptenophos, heterophos, hexaflumuron, hexythiazox, HHDN, hydramethylnon, hydrogen cyanide, hydroprene, hyquincarb,

imicyafos, imidacloprid, imiprothrin, indoxacarb, iodomethane, IPSP, isamidofos, isazofos, isobenzan, isocarbophos, isodrin, isofenphos, isoprocarb, isoprothiolane, isothioate, isoxathion, ivermectin

jasmolin I, jasmolin II, jodfenphos, juvenile hormone I, juvenile hormone II, juvenile hormone III,

kelevan, kinoprene,

lambda cyhalothrin, lead arsenate, lepimectin, leptophos, lindane, lirimfos, lufenuron, lythidathion,

malathion, malonoben, mazidox, mecarbam, mecarphon, menazon, mephosfolan, mercurous chloride, mesulfen, mesulfenfos, metaflumizone, metam, methacrifos, methamidophos, methidathion, methiocarb, methocrotophos, methomyl, methoprene, methoxychlor, methoxyfenozide, methyl bromide, methyl isothiocyanate, methylchloroform, methylene chloride, metofluthrin, metolcarb, metoxadiazone, mevinphos, mexacarbate, milbemectin, milbemycin oxime, mipafox, mirex, MNAF, monocrotophos, morphothion, moxidectin,

naftalofos, naled, naphthalene, nicotine, nifluridide, nikkomycins, nitenpyram, nithiazine, nitrilacarb, novaluron, noviflumuron,

omethoate, oxamyl, oxydemeton methyl, oxydeprofos, oxydisulfoton,

paradichlorobenzene, parathion, parathion methyl, penfluoron, pentachlorophenol, permethrin, phenkapton, phenothrin, phenthoate, phorate, phosalone, phosfolan, phosmet, phosnichlor, phosphamidon, phosphine, phosphocarb, phoxim, phoxim methyl, pirimetaphos, pirimicarb, pirimiphos ethyl, pirimiphos methyl, potassium arsenite, potassium thiocyanate, pp′ DDT, prallethrin, precocene I, precocene II, precocene III, primidophos, proclonol, profenofos, profluthrin, promacyl, promecarb, propaphos, propargite, propetamphos, propoxur, prothidathion, prothiofos, prothoate, protrifenbute, pyraclofos, pyrafluprole, pyrazophos, pyresmethrin, pyrethrin I, pyrethrin II, pyridaben, pyridalyl, pyridaphenthion, pyrifluquinazon, pyrimidifen, pyrimitate, pyriprole, pyriproxyfen,

quassia, quinalphos, quinalphos, quinalphos methyl, quinothion, quantifies,

rafoxanide, resmethrin, rotenone, ryania,

sabadilla, schradan, selamectin, silafluofen, sodium arsenite, sodium fluoride, sodium hexafluorosilicate, sodium thiocyanate, sophamide, spirodiclofen, spiromesifen, spirotetramat, sulcofuron, sulfuram, sulfluramid, sulfotep, sulfur, sulfuryl fluoride, sulprofos,

tau fluvalinate, tazimcarb, TDE, tebufenozide, tebufenpyrad, tebupirimfos, teflubenzuron, tefluthrin, temephos, TEPP, terallethrin, terbufos, tetrachloroethane, tetrachlorvinphos, tetradifon, tetramethrin, tetranactin, tetrasul, theta cypermethrin, thiacloprid, thicrofos, thiocarboxime, thiocyclam, thiodicarb, thiofanox, thiometon, thionazin, thioquinox, thiosultap, thuringiensin, tolfenpyrad, tralomethrin, transfluthrin, transpermethrin, triarathene, triazamate, triazophos, trichlorfon, trichlormetaphos 3, trichloronat, trifenofos, triflumuron, trimethacarb, triprene,

vamidothion, vamidothion, vaniliprole, vaniliprole,

XMC, xylylcarb,

zeta cypermethrin and zolaprofos.

Additionally, any combination of the above pesticidal compounds can be used.

For more information consult “Compendium of Pesticide Common Names” located at http://www.alanwood.net/pesticides/index.html as of the filing date of this document. Also consult “The Pesticide Manual” 14^{th} Edition, edited by C D S Tomlin, copyright 2006 by British Crop Production Council.

Additionally, the following compounds are known as synergists and can be used with compositions disclosed in this document: piperonyl butoxide, piprotal, propyl isome, sesamex, sesamolin, and sulfoxide.

The compositions disclosed in this document may also include or be used with algaecides, pheromones, repellants, animal dips, avicides, disinfectants, semiochemicals, and molluscicides (these categories not necessarily mutually exclusive) for reasons of economy, and synergy.

Other ingredients, or adjuvants, that are often used in agricultural compositions, and that can be included in various compositions described herein, include, but are not limited to, (this is a non-exhaustive and non-mutually exclusive list) wetters, compatibilizing agents (also referred to as “compatibility agents”), antifoam agents, cleaning agents, sequestering agents, drift reduction agents, neutralizing agents and buffers, corrosion inhibitors, dyes, odorants, spreading agents (also referred to as “spreaders”), penetration aids (also referred to as “penetrants”), sticking agents (also referred to as “stickers” or “binders”), dispersing agents, thickening agents (also referred to as “thickeners”) or other rheology agents, stabilizers, emulsifiers, freezing point depressants, antimicrobial agents, and the like.

For example, it is often desirable to include one or more surface-active agents in the compositions, including both solid and liquid formulations, especially those designed to be diluted with carrier before application. Surfactants are sometimes used, either alone or with other additives such as mineral or vegetable oils as adjuvants to spray-tank mixes to improve the biological performance of the pesticide on the target. The types of surfactants used for bioenhancement depend generally on the nature and mode of action of the pesticide. The surface-active agents can be anionic, cationic or nonionic in character and can be employed as emulsifying agents, wetting agents, suspending agents, or for other purposes. However, they are often non-ionics such as: alky ethoxylates; linear aliphatic alcohol ethoxylates; aliphatic amine ethoxylates. Surfactants conventionally used in the art of formulation and which may also be used in the present formulations are described, inter alia, in McCutcheon's Detergents and Emulsifiers Annual, MC Publishing Corp., Ridgewood, N.J., 1998, and in Encyclopedia of Surfactants, Vol. I-III, Chemical Publishing Co., New York, 1980-81. Other examples of suitable surface-active agents include salts of alkyl sulfates, such as diethanolammonium lauryl sulfate; alkylarylsulfonate salts, such as calcium dodecylbenzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutyl-naphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride; polyethylene glycol esters of fatty acids, such as polyethylene glycol stearate; block copolymers of ethylene oxide and propylene oxide; salts of mono and dialkyl phosphate esters; vegetable oils such as soybean oil, rapeseed/canola oil, olive oil, castor oil, sunflower seed oil, coconut oil, corn oil, cottonseed oil, linseed oil, palm oil, peanut oil, safflower oil, sesame oil, tung oil and the like; and esters of the above vegetable oils, particularly methyl esters.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank or other vessel to reduce the wetting time of wettable powders and to improve the penetration of water into water-dispersible granules. Examples of wetting agents used in wettable powder, suspension concentrate, and water-dispersible granule formulations are: sodium lauryl sulphate; sodium dioctyl sulphosuccinate; alkyl phenol ethoxylates; and aliphatic alcohol ethoxylates.

A dispersing agent is a substance which adsorbs onto the surface of particles and helps to preserve the state of dispersion of the particles and prevents them from reaggregating. Dispersing agents are added to agrochemical formulations to facilitate dispersion and suspension during manufacture, and to ensure the particles redisperse into water in a spray tank. They are widely used in wettable powders, suspension concentrates and water-dispersible granules. Surfactants that are used as dispersing agents have the ability to adsorb strongly onto a particle surface and provide a charged or steric barrier to reaggregation of particles. The most commonly used surfactants are anionic, non-ionic, or mixtures of the two types. For wettable powder formulations, the most common dispersing agents are sodium lignosulphonates. For suspension concentrates, very good adsorption and stabilization are obtained using polyelectrolytes, such as sodium naphthalene sulphonate formaldehyde condensates. Tristyrylphenol ethoxylate phosphate esters are also used. Non-ionics such as alkylarylethylene oxide condensates and EO-PO block copolymers are sometimes combined with anionics as dispersing agents for suspension concentrates. In recent years, new types of very high molecular weight polymeric surfactants have been developed as dispersing agents. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersing agents used in agrochemical formulations are: sodium lignosulphonates; sodium naphthalene sulphonate formaldehyde condensates; tristyrylphenol ethoxylate phosphate esters; aliphatic alcohol ethoxylates; alky ethoxylates; EO-PO block copolymers; and graft copolymers.

An emulsifying agent is a substance which stabilizes a suspension of droplets of one liquid phase in another liquid phase. Without the emulsifying agent the two liquids would separate into two immiscible liquid phases. The most commonly used emulsifier blends include alkylphenol or aliphatic alcohol with 12 or more ethylene oxide units and the oil-soluble calcium salt of dodecylbenzene sulphonic acid. A range of hydrophile-lipophile balance (“HLB”) values from 8 to 18 will normally provide good stable emulsions. Emulsion stability can sometimes be improved by the addition of a small amount of an EO-PO block copolymer surfactant.

A solubilizing agent is a surfactant which will form micelles in water at concentrations above the critical micelle concentration. The micelles are then able to dissolve or solubilize water-insoluble materials inside the hydrophobic part of the micelle. The types of surfactants usually used for solubilization are non-ionics: sorbitan monooleates; sorbitan monooleate ethoxylates; and methyl oleate esters.

Organic solvents are used mainly in the formulation of emulsifiable concentrates, ULV formulations, and to a lesser extent granular formulations. Sometimes mixtures of solvents are used. The first main groups of solvents are aliphatic paraffinic oils such as kerosene or refined paraffins. The second main group and the most common comprises the aromatic solvents such as xylene and higher molecular weight fractions of C9 and C10 aromatic solvents. Chlorinated hydrocarbons are useful as cosolvents to prevent crystallization of pesticides when the formulation is emulsified into water. Alcohols are sometimes used as cosolvents to increase solvent power.

Thickeners or gelling agents are used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose. Examples of these types of materials include, but are not limited to, guar gum; locust bean gum; carrageenam; alginates; methyl cellulose; sodium carboxymethyl cellulose (SCMC); hydroxyethyl cellulose (HEC). Other types of anti-settling agents are based on modified starches, polyacrylates, polyvinyl alcohol and polyethylene oxide. Another good anti-settling agent is xanthan gum.

Microorganisms cause spoilage of formulated products. Therefore preservation agents are used to eliminate or reduce their effect. Examples of such agents include, but are not limited to: propionic acid and its sodium salt; sorbic acid and its sodium or potassium salts; benzoic acid and its sodium salt; p-hydroxy benzoic acid sodium salt; methyl p-hydroxy benzoate; and 1,2-benzisothiazalin-3-one (BIT).

The presence of surfactants, which lower interfacial tension, often causes water-based formulations to foam during mixing operations in production and in application through a spray tank. In order to reduce the tendency to foam, anti-foam agents are often added either during the production stage or before filling into bottles. Generally, there are two types of anti-foam agents, namely silicones and non-silicones. Silicones are usually aqueous emulsions of dimethyl polysiloxane while the non-silicone anti-foam agents are water-insoluble oils, such as octanol and nonanol, or silica. In both cases, the function of the anti-foam agent is to displace the surfactant from the air-water interface.

For further information see “CHEMISTRY AND TECHNOLOGY OF AGROCHEMICAL FORMULATIONS” edited by D. A. Knowles, copyright 1998 by Kluwer Academic Publishers. Also see “INSECTICIDES IN AGRICULTURE AND ENVIRONMENT—RETROSPECTS AND PROSPECTS” by A. S. Perry, I. Yamamoto, I. Ishaaya, and R. Perry, copyright 1998 by Springer-Verlag.

Pesticide compositions can be frequently applied as aqueous suspensions or emulsions prepared from concentrated formulations of such compositions. Such water-soluble, water-suspendable, or emulsifiable formulations are either solids, usually known as wettable powders, or water dispersible granules, or liquids usually known as emulsifiable concentrates, or aqueous suspensions. Wettable powders, which may be compacted to form water dispersible granules, comprise an intimate mixture of the pesticide composition, a carrier, and surfactants. The carrier is usually chosen from among the attapulgite clays, the montmorillonite clays, the diatomaceous earths, or the purified silicates. Effective surfactants, which can comprise from about 0.5% to about 10% of the wettable powder, are found among sulfonated lignins, condensed naphthalenesulfonates, naphthalenesulfonates, alkylbenzenesulfonates, alkyl sulfates, and nonionic surfactants such as ethylene oxide adducts of alkyl phenols.

Emulsifiable concentrates comprise a convenient concentration of a pesticide composition dissolved in a carrier that is either a water miscible solvent or a mixture of water-immiscible organic solvent and emulsifiers. Useful organic solvents include aromatics, especially xylenes and petroleum fractions, especially the high-boiling naphthalenic and olefinic portions of petroleum such as heavy aromatic naphtha. Other organic solvents may also be used, such as the terpenic solvents including rosin derivatives, aliphatic ketones such as cyclohexanone, and complex alcohols such as 2-ethoxyethanol. Suitable emulsifiers for emulsifiable concentrates are chosen from conventional anionic and nonionic surfactants.

Aqueous suspensions comprise suspensions of water-insoluble pesticide compositions dispersed in an aqueous carrier. Suspensions are prepared by finely grinding the pesticide composition and vigorously mixing it into a carrier comprised of water and surfactants. Ingredients, such as inorganic salts and synthetic or natural gums, may also be added, to increase the density and viscosity of the aqueous carrier. It is often most effective to grind and mix the pesticide composition at the same time by preparing the aqueous mixture and homogenizing it in an implement such as a sand mill, ball mill, or piston-type homogenizer.

Pesticide compositions may also be applied as granular formulations that are particularly useful for applications to the soil. Granular formulations include the pesticide composition dispersed in a carrier such as, for example, a carrier that comprises clay or a similar substance. Such formulations are usually prepared by dissolving the pesticide composition in a suitable solvent and applying it to a granular carrier which has been pre-formed to the appropriate particle size, in the range of from about 0.5 to 3 mm. Such formulations may also be formulated by making a dough or paste of the carrier and pesticide composition and crushing and drying to obtain the desired granular particle size.

Dusts including a pesticide composition are prepared by intimately mixing the pesticide composition in powdered form with a suitable dusty agricultural carrier, such as kaolin clay, ground volcanic rock, and the like. Dusts can be applied as a seed dressing, or as a foliage application with a dust blower machine.

It is equally practical to apply a pesticide composition in the form of a solution in an appropriate organic solvent, usually petroleum oil, such as the spray oils, which are widely used in agricultural chemistry.

Pesticide compositions can also be applied in the form of an aerosol formulation. In such formulations, the pesticide composition is dissolved or dispersed in a carrier, which is a pressure-generating propellant mixture. The aerosol formulation is packaged in a container from which the mixture is dispensed through an atomizing valve.

Pesticide baits are formed when the pesticide composition is mixed with food or an attractant or both. When the pests eat the bait they also consume the pesticide composition. Baits may take the form of granules, gels, flowable powders, liquids, or solids. They may be used in or around pest harborages.

Fumigants are pesticides that have a relatively high vapor pressure and hence can exist as a gas in sufficient concentrations to kill pests in soil or enclosed spaces. The toxicity of the fumigant is proportional to its concentration and the exposure time. They are characterized by a good capacity for diffusion and act by penetrating the pest's respiratory system or being absorbed through the pest's cuticle. Fumigants are applied to control stored product pests under gas proof sheets, in gas sealed rooms or buildings or in special chambers.

Oil solution concentrates are made by dissolving a pesticide composition in a solvent that will hold the pesticide composition in solution. Oil solutions of a pesticide composition usually provide faster knockdown and kill of pests than other formulations due to the solvents themselves having pesticidal action and the dissolution of the waxy covering of the integument increasing the speed of uptake of the pesticide. Other advantages of oil solutions include better storage stability, better penetration of crevices, and better adhesion to greasy surfaces.

Another embodiment is an oil-in-water emulsion, wherein the emulsion comprises oily globules which are each provided with a lamellar liquid crystal coating and are dispersed in an aqueous phase, wherein each oily globule comprises at least one compound which is agriculturally active, and is individually coated with a monolamellar or oligolamellar layer comprising: (1) at least one non-ionic lipophilic surface-active agent, (2) at least one non-ionic hydrophilic surface-active agent and (3) at least one ionic surface-active agent, wherein the globules having a mean particle diameter of less than 800 nanometers. Further information on the embodiment is disclosed in U.S. patent publication 20070027034 published Feb. 1, 2007, having patent application Ser. No. 11/495,228.

For further information consult “INSECT PEST MANAGEMENT” 2nd Edition by D. Dent, copyright CAB International (2000). Additionally, for more detailed information consult “HANDBOOK OF PEST CONTROL—THE BEHAVIOR, LIFE HISTORY, AND CONTROL OF HOUSEHOLD PESTS” by Arnold Mallis, 9th Edition, copyright 2004 by GIE Media Inc.

The actual amount of a pesticide composition to be applied to loci of pests is not critical and can readily be determined by those skilled in the art. In general, concentrations from about 0.01 grams of pesticide per hectare to about 5000 grams of pesticide per hectare are expected to provide good control.

The locus to which a pesticide is applied can be any locus inhabited by a pest, for example, vegetable crops, fruit and nut trees, grape vines, ornamental plants, domesticated animals, the interior or exterior surfaces of buildings, and the soil around buildings.

Generally, with baits, the baits are placed in the ground where the pests can come into contact with the bait. Baits can also be applied to a surface of a building, (horizontal, vertical, or slant, surface) where, for example, ants, termites, cockroaches, and flies, can come into contact with the bait.

Because of the unique ability of the eggs of some pests to resist pesticides repeated applications may be desirable to control newly emerged larvae.

Systemic movement of pesticides in plants may be utilized to control pests on one portion of the plant by applying the pesticides to a different portion of the plant. For example, control of foliar-feeding insects or stem-feeding insects can be controlled by drip irrigation or furrow application, or by treating the seed before planting. Seed treatment can be applied to all types of seeds, including those from which plants genetically transformed to express specialized traits will germinate. Representative examples include those expressing proteins toxic to invertebrate pests, such as Bacillus thuringiensis or other insecticidal toxins, those expressing herbicide resistance, such as “Roundup Ready” seed, or those with “stacked” foreign genes expressing insecticidal toxins, herbicide resistance, nutrition-enhancement or any other beneficial traits. Furthermore, such seed treatments with the compositions disclosed in this document can further enhance the ability of a plant to better withstand stressful growing conditions. This results in a healthier, more vigorous plant, which can lead to higher yields at harvest time.

Certain compositions disclosed in this document are suitable for controlling endoparasites and ectoparasites in the veterinary medicine sector or in the field of animal keeping. The compositions are applied here in a known manner, such as by oral administration in the form of, for example, tablets, capsules, drinks, granules, by dermal application in the form of, for example, dipping, spraying, pouring on, spotting on, and dusting, and by parenteral administration in the form of, for example, an injection.

Certain compositions disclosed in this document can also be employed advantageously in livestock keeping, for example, cattle, sheep, pigs, chickens, and geese. Suitable formulations are administered orally to the animals with the drinking water or feed. The dosages and formulations that are suitable depend on the species.

The concentration of the Spinosyn and the thiamethoxam in a synergistic formulation of one embodiment is from 0.001 to 98 percent by weight. In another embodiment, the concentration is from 0.01 to 90 percent by weight. In a formulation embodiment designed to be employed as a concentrate, the active ingredients are present in a concentration from 5 to 98 weight percent, preferably 10 to 90 weight percent. Such concentrate formulations are typically diluted with an inert carrier, such as water, before application. In one embodiment, a diluted composition to be applied to a field locus includes from 0.0001 to 1 weight percent active ingredient. In another embodiment, the composition includes from 0.001 to 0.05 weight percent active ingredient.

The present compositions can be applied to a locus by the use of conventional ground or aerial dusters, sprayers, and granule applicators, by addition to irrigation or paddy water, and by other conventional means known to those skilled in the art.

In one aspect the present disclosure, the synergistic mixture of a Spinosyn and thiamethoxam is delivered to a field locus together with seeds as a seed treatment. As used herein, the term “seed” denotes any resting stage of a plant that is physically detached from the vegetative stage of a plant and/or may be stored for prolonged periods of time and/or can be used to re-grow another plant individual of the same species. The term “resting” refers to a state wherein the plant retains viability, within reasonable limits, in spite of the absence of light, water and/or nutrients essential for the vegetative (i.e. non-seed) state.

When seeds treated with the synergistic mixture are planted, the synergistic mixture protects the plants that grow after germination of the seed from damage by cutworms, and thus improve the growth characteristics of the plant through improved control of cutworms. Accordingly, the present disclosure includes a method of protecting plants that grow at a later point in time against damage by cutworms, which method comprises treating seeds with a Spinosyn, thiamethoxam, and optionally one or more formulation auxiliaries. In one embodiment, the Spinosyn is Spinosad. In addition to treating seeds, the present disclosure also contemplates the treatment of other plant propagation materials. Thus, the descriptions herein involving seed treatment are also intended to apply equally well to methods, compositions and materials involving the treatment of other plant propagation material with the synergistic combination. The term “plant propagation material” is used herein to refer to all the generative parts of the plant, including seeds, which can be used for the multiplication of the plant and/or vegetative plant material such as cuttings and tubers (for example, potatoes) including, for example, roots, fruits, tubers, bulbs, rhizomes and other plant parts.

A variety of methods for applying pesticides on to seeds are known in the art, and include dressing, coating, pelleting and soaking application methods. In various embodiments, the seed treatment can be applied as a thin film (such as a dressing) of the formulation including the active ingredient on a seed, where the original size and/or shape of the seed are recognizable; or as a thick film (such as a coating or pelleting) with many layers of the same or different materials where the original shape and/or size of the seed is no longer recognizable.

Even distribution of the active ingredients and adherence thereof to seeds is desired during treatment of the seeds. The Spinosyn and thiamethoxam can be applied to or otherwise used to treat seeds either simultaneously, or sequentially, in any order. Similarly if one or more other active ingredient is included in the composition in addition to a Spinosyn and thiamethoxam, then those active ingredients can be applied to or otherwise used to treat seeds either simultaneously, or sequentially, in any order. In one embodiment, Spinosyn and thiamethoxam are applied simultaneously. In another embodiment, after the Spinosyn and thiamethoxam are applied to a seed, an over-coating that does not include a pesticide is then applied to the treated seed. In this embodiment, the previously treated seed can be enveloped with an over-coating comprising a binder formulation as described herein (i.e., one that does not include a pesticide mixture). The Spinosyn and thiamethoxam may be applied to seeds either in pure form, i.e., as a solid active ingredient, for example, in a specific particle size or, more typically, together in the form of a formulation with at least one of a wide variety of auxiliary ingredients (also referred to as adjuvants).

Each of the Spinosyn and thiamethoxam can be obtained from a separate formulation source and mixed together, optionally with other pesticides or other auxiliary ingredients, to form the seed treatment composition. Alternatively, Spinosyn and thiamethoxam can be obtained or provided as a single formulation mixture source and optionally mixed together with other pesticides or other auxiliary ingredients to form a seed treatment composition. Whereas commercial products will preferably be formulated as concentrates (i.e., as a pre-mix composition), the end user will normally employ dilute formulations (i.e., a tank mix composition) for treatment of the seeds. Accordingly, the present disclosure provides in one embodiment a seed treatment composition comprising Spinosyn and thiamethoxam, and optionally one or more other pesticides, and optionally one or more other auxiliary ingredients, which composition may be in the form of a tank-mix or pre-mix composition.

Examples of formulation types suitable for tank-mix compositions include solutions, dilute emulsions, suspensions, or a mixture thereof, and dusts. Generally, an aqueous tank-mix is preferred. Examples of seed treatment pre-mix formulations types include wettable powders for seed treatment slurry, solution for seed treatment, emulsions for seed treatment, suspension concentrate for seed treatment, water dispersible granules, and aqueous capsule suspension. The tank-mix compositions are generally prepared by diluting with a solvent (for example, water) the one or more pre-mix compositions including the pesticides, and optionally further auxiliaries.

In one embodiment, a tank-mix formulation for seed treatment application comprises 0.25 to 80% of the pesticidal mixture and 99.75 to 20% of one or more auxiliary ingredient (including, for example, a solvent such as water). In one embodiment, the one or more auxiliary ingredient comprises a surfactant in an amount of 0 to 40% based on the tank-mix formulation. In another embodiment, a tank-mix formulation for seed treatment application comprises 1 to 75% of the pesticidal mixture and 99 to 25% of one or more auxiliary ingredient (including, for example, a solvent such as water). In another embodiment, the one or more auxiliary ingredient comprises a surfactant in an amount of 0.5 to 30% based on the tank-mix formulation.

In one embodiment, a pre-mix formulation for seed treatment application comprises 0.5 to 99.9% of the pesticidal mixture and 99.5 to 0.1% of one or more auxiliary ingredient (including, for example, a solvent such as water). In one embodiment, the one or more auxiliary ingredient comprises a surfactant in an amount of 0 to 50% based on the pre-mix formulation. In another embodiment, a pre-mix formulation for seed treatment application comprises 1 to 95% of the pesticidal mixture and 99 to 5% of one or more auxiliary ingredient (including, for example, a solvent such as water). In another embodiment, the one or more auxiliary ingredient comprises a surfactant in an amount of 0.5 to 40%, based on the pre-mix formulation. Preferred seed treatment pre-mix formulations are aqueous suspension concentrates.

In one embodiment, the treatment occurs before sowing or planting of the seed so that the sown or planted seed has been pre-treated with the synergistic mixture. The seed treatment composition can be applied to the seed at any time from the harvest of the seed to the sowing or planting of the seed in the ground for the purpose of germination and growth of the plant. For example, the treatment may be carried out several weeks or months, for example up to 12 months, before sowing or planting the seed, for example in the form of a seed dressing treatment, without a substantially reduced efficacy being observed. Seeds can be treated, for example, at a central location and then dispersed for planting. This permits the person who plants the seeds to avoid the handling and use of active ingredients and to merely handle and plant the treated seeds in a manner that is conventional for regular untreated seeds, which reduces human exposure.

Although it is believed that the present method can be applied to a seed in any physiological state, it is preferred that the seed be in a sufficiently durable state that it incurs no significant damage during the treatment process. The seed preferably is one that has been harvested from the field; removed from the plant; and separated from any cob, stalk, outer husk, and surrounding pulp or other non-seed plant material. The seed preferably also is biologically stable to the extent that the treatment would cause no biological damage to the seed. It is believed that the treatment can be applied to the seed at any time between harvest of the seed and sowing of the seed or during the sowing process. The seed may also be primed either before or after the treatment. Treatment to an unsown seed is not meant to include those practices in which the pesticide is applied to the soil but would include any application practice that would target the seed during the planting process. In one embodiment, for example, the treatment can be applied to seed that has been harvested, cleaned and dried to a moisture content below about 15% by weight. In an alternative embodiment, the seed can be one that has been dried and then primed with water and/or another material and then re-dried before or during the treatment with a seed treatment composition as described herein. In one embodiment, the seed to be treated is thus substantially dry. “Substantially dry” is used herein to refer to a seed that has a moisture content which results if the seed is allowed to equilibrate in an air atmosphere at 20 to 30° C. and 30-90% relative humidity, e.g. at 25° C. and 50% relative humidity.

The weight ratio of a Spinosyn and thiamethoxam and the amount used on the seeds can vary according to various factors including, for example, the species of the plant whose seeds are being treated (for example, less active ingredients would be expected to be needed to treat sunflower seeds than for alfalfa seeds based on equivalent weight of seeds) and is such that the combinations are an effective amount to provide the desired pesticidal action and can be determined by biology trials. Another factor that would bear on the target weight ratio and amount is the type of propagation material being treated (e.g., seed or tuber). The weight ratio of the Spinosyn to thiamethoxam in a seed treatment is generally selected to give the desired synergistic action. In one embodiment, the weight ratio of the Spinosyn to thiamethoxam in the seed treatment is within the range of between about 1:150 and about 75:1. In yet another embodiment, the ratio by weight between the Spinosyn and the thiamethoxam is in the range of 1:75 to 40:1. In still another embodiment, the ratio by weight between the Spinosyn or a formulation including the Spinosyn and the thiamethoxam is in the range of 1:15 to 10:1. In still yet another embodiment, the ratio by weight between the Spinosyn or a formulation including the Spinosyn and the thiamethoxam is in the range of 1:2 to 1:1. However, it should be understood that alternative values for the ratio by weight between the Spinosyn and the thiamethoxam are possible.

The exact amount of an active ingredient included in the seed treatment composition can vary depending upon the size and other characteristics (e.g., surface structure, etc.) of the seed to be coated and other considerations. The active component of the seed treatment formulation should not inhibit germination of the seed. The application rates can range, for example, from 0.05 mg to 5 mg of the combined Spinosyn and thiamethoxam per seed. In other embodiments, the combined application rate of Spinosyn and thiamethoxam for sunflower seeds range from 0.1 mg to 2.5 mg per seed or from 0.2 mg to 1.5 mg per seed.

In one embodiment in which a Spinosyn and thiamethoxam are applied simultaneously to a seed in a seed treatment composition, the seed treatment composition includes, in addition to a Spinosyn and thiamethoxam, at least one auxiliary ingredient effective to adhere the Spinosyn and thiamethoxam to seeds. In one embodiment, the seed treat composition includes a binder (also referred to as a “sticker”) that operates to adhere the Spinosyn and thiamethoxam, and optionally other ingredients, to the seed being treated. A binder can be provided, for example, in the form of a formulated binder mixture. A seed treatment composition (also referred to as a “seed treatment mixture” or “slurry”) can be made by combining the formulated binder mixture with a formulated pesticide mixture and diluent water to provide a slurry prior to (often immediately prior to) applying the slurry to seeds to form a coating over the seeds. Both the formulated binder mixture and the formulated pesticide mixture can include other auxiliary ingredients as described herein. Alternatively, the binder formulation itself can include the Spinosyn, the thiamethoxam and other optional ingredients.

In one embodiment, the amount of active component included in the seed treatment composition is based on an amount of the active ingredient or ingredients necessary to be pesticidally effective when present in a seed coating. In one embodiment, a seed treatment composition includes from about 20% to about 70% by weight of an active component and from about 20% to about 60% by weight of a binder formulation as described herein, with the balance, if any, including water and optionally other ingredients. In another embodiment, a seed treatment formulation includes from about 30% to about 60% by weight of an active component and from about 25% to about 45% by weight of a binder formulation. These weight percent values are based on the “as added” amounts of the active component and binder formulation, respectively.

The slurry can be applied to a seed in a variety of manners known in the seed treating art, including but not limited to mixing in a container (e.g., a bottle, bag or tumbler), mechanical application, tumbling, spraying, and immersion, followed by drying. The seed treatment composition can be applied to seeds in a batch treatment process or in a continuous treatment process. In one representative batch treatment process, the seeds to be treated are introduced to a batch treatment tank and the seed treatment composition is then added and mixed with the seeds. Alternatively a continuous treatment process can be used to apply the seed treatment composition to seeds in which a stream of seeds are introduced into a receptacle containing the seed treatment slurry and, after contacting the formulation, recovered from the receptacle for drying. A stream of seed treatment composition can continuously flow into the receptacle as well to replenish quantities of the composition that are removed with treated seeds. Examples of seed coating techniques and equipment that can be employed include fluidized bed techniques, the roller mill method, rotary seed treaters, drum coaters, side vended pans, tumble mixers and spouted beds. Examples of devices that can be employed include a Hege seed treater, which rotates as the formulation is being added to the seeds, and a Universal Batch seed treater (NIKLAS). Mixing is preferably continued until the slurry is distributed uniformly on the seeds (i.e., uniform coatings over all of the seeds to be treated and an even coating on each individual seed). The seeds may be pre-sized before coating, if desired.

After application of the slurry (whether in a batch process or a continuous process) the seeds are allowed a period of time to dry. For example, the seeds can be spun in a bowl for a period of time, for example, at least 15 seconds, to allow for drying. Different time periods may be needed to allow for variability in drying conditions due to weather, to allow for variability in the composition of the slurry, and/or to allow for different seed sizes. Moreover, heat can be provided, if desired, to decrease drying times, for example, in the form of a heated stream of air. After drying, the coated seeds can undergo a size separation or classification process, if desired. Such procedures are known in the art.

A binder formulation used to make a seed treatment composition in some embodiments as described above can be, for example, a concentrated slurry of binder ingredients in water or a re-dispersible solids composition. A wide variety of polymeric carriers or stickers have been described in the art as being operable to adhere the pesticidal mixture to the seeds, and therefore useful in binder formulations, and suitable binder formulation products are available commercially. For example, a suitable binder formulation can include one or more of the following polymeric carriers: polyesters, polyether esters, polyanhydrides, polyester urethanes, polyester amides; polyvinyl acetates; polyvinyl acetate copolymers; polyvinyl alcohols and tylose; polyvinyl alcohol copolymers; polyvinylpyrolidones; polysaccharides, including starches, modified starches and starch derivatives, dextrins, maltodextrins, alginates, chitosanes and celluloses, cellulose esters, cellulose ethers and cellulose ether esters including ethylcelluloses, methylcelluloses, hydroxymethylcelluloses, hydroxypropylcelluloses and carboxymethylcellulose; fats; oils; proteins, including casein, gelatin and zeins; gum arabics; shellacs; vinylidene chloride and vinylidene chloride copolymers; lignosulfonates, in particular calcium lignosulfonates; polyacrylates, polymethacrylates and acrylic copolymers; polyvinylacrylates; polyethylene oxide; polybutenes, polyisobutenes, polystyrene, polybutadiene, polyethyleneamines, polyethylenamides; acrylamide polymers and copolymers; polyhydroxyethyl acrylate, methylacrylamide monomers; and polychloroprene. Copolymers of the polymers listed above are also envisioned, one suitable example being polystyrene-polybutadiene copolymers. In one embodiment, the binder formulation includes a latex carrier. In one embodiment, the latex carrier in the binder formulation comprises a styrene-acrylate based copolymer. The term “latex” as used herein means a dispersion in an aqueous carrier of polymer particles, in this case, particles of a styrene-acrylate based copolymer. In one embodiment, the copolymer includes at least two of the following comonomers: styrene comonomers, butyl acrylate comonomers, acrylonitrile comonomers and acrylic acid comonomers. In another embodiment, the copolymer includes at least three of the above comonomers. In yet another embodiment, the copolymer includes all four of these comonomers.

The binder formulations, and thus the seed treatment compositions, can optionally also include other auxiliary ingredients, such as, for example, any auxiliary ingredient that is customary in agrochemical formulations and does not unduly interfere with the desired physical properties of a coated seed made using the formulation (e.g., flowability, dust-off and plantability characteristics). The selection of auxiliaries to be included can depend on the particular active ingredients selected for inclusion or the type of seed being treated, for example. Examples for suitable auxiliary ingredients include solvents, carriers, protective colloids, organic and inorganic thickeners, preservatives (including bactericides and other biocides), humectants, antifreeze ingredients, antifoam ingredients and if appropriate colorants. In one embodiment, the binder formulation includes at least one product stabilizing ingredient such as, for example, an antifoam ingredient, a thickener, an antifreeze ingredient, a preservative, and combinations thereof. In other embodiments, additional ingredients can be included in a binder formulation as described herein. Examples of additional ingredients include humectants, colorants, waxes, inorganic particulate materials and the like.

Antifreeze ingredients that can be employed in an aqueous composition include those substances which lead to a depression of the melting point of water. Suitable antifreeze ingredients include, for example and without limitation, ethylene glycol, 1,2-propylene glycol, 1,3-propylene glycol, 1,2-butanediol, 1,3-butanediol, 1,4-butanediol, 1,4-pentanediol, 3-methyl-1,5-pentanediol, 2,3-dimethyl-2,3-butanediol, trimethylol propane, mannitol, sorbitol, glycerol, pentaerythritol, 1,4-cyclohexanedimethanol, xylenol, bisphenols such as bisphenol A or the like. In addition, ether alcohols such as diethylene glycol, triethylene glycol, tetraethylene glycol, polyoxyethylene or polyoxypropylene glycols of molecular weight up to about 4000, diethylene glycol monomethylether, diethylene glycol monoethylether, triethylene glycol monomethylether, butoxyethanol, butylene glycol monobutylether, dipentaerythritol, tripentaerythritol, tetrapentaerythritol, diglycerol, triglycerol, tetraglycerol, pentaglycerol, hexaglycerol, heptaglycerol, octaglycerol and combinations thereof. An antifreeze ingredient can be present in a binder formulation, for example, at a concentration of from about 1 to about 20% by weight.

The term “thickener” is used herein to refer to compounds that impart a modified flowability to formulations, including, for example, certain viscosity characteristics. In one embodiment the thickener is a compound that imparts an increased viscosity under static conditions and a lower viscosity during agitation. Examples of suitable thickeners include polysaccharides and organic and inorganic clays. In one embodiment, the thickener is a water-soluble polymer that exhibits pseudoplastic properties in an aqueous medium, such as, for example, gum arabic, gum karaya, gum tragacanth, guar gum, locust bean gum, xanthan gum, carrageenan, alginate salt, casein, dextran, pectin, agar, 2-hydroxyethyl starch, 2-aminoethyl starch, 2-hydroxy ethyl cellulose, methyl cellulose, carboxymethyl cellulose salt, cellulose sulfate salt, polyacrylamide, alkali metal salts of the maleic anhydride copolymers, alkali metal salts of poly(meth)acrylate, and the like. This list is not intended to be exhaustive, however, and a wide variety of other thickeners can be employed. A wide variety of thickeners are available commercially, including, for example, the following: Kelzan® (CP Kelco, U.S.A.), Rhodopol® 23 (Rhodia, France), Veegum® (R.T. Vanderbilt, U.S.A.) or Attaclay® (Engelhard Corp., NJ, USA). A thickener can be present in a binder formulation, for example, at a concentration of from about 1 to about 25% by weight.

Antifoam ingredients that can be employed include those substances that inhibit the development of foam, a variety of which are conventionally used for formulating agrochemical active ingredients. Examples of antifoam ingredients that can be employed include silicone emulsions (such as e.g. Silikon® SRE, Wacker, Germany or Rhodorsil®, Rhodia, France), long chain alcohols, fatty acids, salts of fatty acids, fluoroorganic compounds and compositions thereof. For example, suitable anti-foaming ingredients include polyethylene glycol, glycerine, mineral oil defoamers, silicone defoamers, non-silicone defoamers (such as polyethers, polyacrylates), dimethylpolysiloxanes (silicone oils), arylalkyd modified polysiloxanes, and polyether siloxane copolymer including fumed silica. Silicone antifoam emulsions are particularly suitable and are included as the antifoam ingredient in one embodiment. In another embodiment, the antifoam ingredient comprises magnesium stearate. An antifoam ingredient can be present in a binder formulation, for example, at a concentration of up to about 2% by weight, alternatively from about 0.01 to about 1%.

One or more preservatives (e.g., antimicrobial agents or other biocidal agents) may also be included for preservation and stabilization of the binder formulation. Examples of suitable bactericides include those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). As further examples, suitable preservatives include MIT (2-methyl-4-isothiazolin-3-one), BIT (1,2-benzisothiazolin-3-one, which can be obtained from Avecia, Inc. as Proxel GXL as a solution in sodium hydroxide and dipropylene glycol), 5-chloro-2-(4-chlorobenzyl)-3(2H)-isothiazolone, 5-chloro-2-methyl-2H-isothiazol-3-one, 5-chloro-2-methyl-2H-isothiazol-3-one, 5-chloro-2-methyl-2H-isothiazol-3-one-hydrochloride, 4,5-dichloro-2-cyclohexyl-4-isothiazolin-3-one, 4,5-dichloro-2-octyl-2H-isothiazol-3-one, 2-methyl-2H-isothiazol-3-one, 2-methyl-2H-isothiazol-3-one-calcium chloride complex, 2-octyl-2H-isothiazol-3-one and benzyl alcohol hemiformal. A preservative can be present in a binder formulation, for example, at a concentration of up to about 2% by weight, alternatively from about 0.01 to about 1%.

In an embodiment including a colorant, the colorant can be included in a binder formulation, which can be diluted and mixed with an active component to form a seed treatment composition. Alternatively, a colorant can be mixed with the active component prior to combination with the binder formulation, or can be added to a mixer with the binder formulation and active component as an independent ingredient used to make a seed treatment composition. Of course, in alternative embodiments, the colorant can be omitted entirely. One advantage of having a colorant (also referred to as a “coloring ingredient”), such as a dye or pigment (and the like such as described in the CFR 180.1001) included in the seed treatment composition is so that an observer can immediately determine that the seeds are treated. Another potential advantage is that a color coding system can be employed to convey information regarding the specific type of coating present on a treated seed. A dye can also be useful to indicate to the user the degree of uniformity of the coating applied.

Colorants that can be employed in a seed treatment composition as described herein include a wide variety of dyes and pigments that are conventionally used for such purposes, and that do not interfere with the flowability, dust-off and plantability characteristics of a coated seed made using the formulation. In this context, both pigments, which are sparingly soluble in water, and dyes, which are soluble in water, may be used. Examples of colorants (i.e. dyes and pigments) that can be employed include those known under the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108. In one embodiment, a colorant is used that is also active as repellents for warm-blooded animals. Examples of such colorants include iron oxide, TiO₂, Prussian blue, anthraquinone dyes, azo dyes and metal phthalocyanine dyes. This list is provided only to set forth some examples of colorants that can be employed, it being understood that a wide variety of alternative colorants are known and available commercially that can be included as alternatives to, or in addition to, the above, and such are expressly contemplated by the present application.

In addition to the preservatives discussed above, additional active ingredients that can optionally be included in the seed treatment compositions include nutrients (including, for example, fertilizers or micronutrients), plant growth regulators (including, for example, inoculants), one or more other active ingredient effective to control microbes such as fungi, bacteria, inclusive of mycoplasmas, viruses and viroids or useful for another purpose (including, for example, aphicides, acaricides, desiccants, bactericides, chemosterilants, defoliants, antifeedants, fungicides, herbicides, herbicide safeners, insect attractants, insecticides, insect repellents, molluscicides, nematicides, mating disrupters, plant activators, rodenticides, mammal repellents, synergists, bird repellents and virucides) and additional pesticides (including, for example, the additional pesticides listed hereinabove).

In one embodiment, the additional active ingredient is effective to protect seeds and/or the resulting plants against diseases in the soil, which mostly occur in the early stages of plant development. The following additional active ingredients which can be included in compositions described herein are intended to illustrate possible additional active ingredients, but not to impose any limitation:

Typical fungicidal ingredients include Captan (N-trichloromethyl)thio-4-cyclohexane-1,2-dicarboximide), Thiram (tetramethylthioperoxydicarbonic diamide; commercially available under the tradename Proseed), Metalaxyl (methyl N-(2,6-dimethylphenyl)-N-(methoxyacetyl)-DL-alaninate), Fludioxonil (4-(2,2-difluoro-1,3-benzodioxol-4-yl)-1-H-pyrrol-3-carbonitril; commercially available in a blend with mefenoxam under the tradename Maxim XL), difenoconazole (commercially available under the tradename Dividend 3FS), carbendazim iprodione (commercially available under the tradename Rovral®), ipconazole, mefenoxam (commercially available under the tradename Apron XL), tebuconazole, carboxin, thiabendazole, azoxystrobin, prochloraz, and Oxadixyl (N-(2,6-dimethylphenyl)-2-methoxy-N-(2-oxo-3-oxazolidinyl)acetamide).

Typical bactericidal ingredients include streptomycin, penicillins, tetracyclines, ampicillin, and oxolinic acid.

Typical insecticidal and nematicidal ingredients include those listed hereinabove as additional pesticides.

Examples of suitable waxes include natural wax (e.g., beeswax or lanolin), vegetable wax (e.g., Carnauba), mineral wax (e.g., montan or paraffin), synthetic wax (e.g., polyethylene (polar or nonpolar), polypropylene, Fischer-Tropsch, or polybutene), or another lubricant such as, for example, polytetrafluoroethylene.

Examples of suitable inorganic particulate materials include particulate mica (for example, micronized mica) and particulate talc.

In one embodiment, the seeds treated as described herein include seeds of sunflower, corn, alfalfa, tomato, tobacco, soybeans, and some weeds. Other examples of seeds that can be treated include seeds of wheat, barley, oat, rye, spelt, rice, sugar beet, cotton, millet varieties such as sorghum, beans, peas, other oil plants such as canola, rape, cabbages, tomatoes, eggplants (aubergines), pepper, other vegetables, spices and flowers. These lists are not intended to be limiting, but rather to provide examples of some types of seeds that can be treated as described herein. Suitable target crops also include transgenic crop plants of the foregoing. In one embodiment, the seed is from sunflower.

Reference will now be made to the following Examples, which describe experimental work directed to the subject matter of the present application. It is understood that no limitation to the scope of the application is intended thereby. The Examples are intended to be illustrative, are provided solely to promote a full understanding of the concepts embodied in the application, and are not intended to be limiting or otherwise restrictive as to the nature and scope of the inventions set forth herein.

### EXAMPLES

Bioefficacy tests were performed by planting sunflower seeds treated with a seed treatment composition including Spinosad and thiamethoxam. The data set forth below show that seeds treated with Spinosad and thimethoxam as described in the present application exhibit a synergistic effect in controlling cutworms.

In the experiments described herein, the seeds were treated by contacting the seeds with an aqueous formulation of the identified active ingredients without a binder.

### Example One

### Preparation of Seed Treatment Compositions Including Active Ingredients

Seed treatment compositions were made by thoroughly blending the active ingredients set forth in Table 1 with water in predetermined amounts effective to provide the identified amounts of respective active compounds on the treated sunflower seeds.

TABLE 1

| Seed | | Tracer | Cruiser |
|---|---|---|---|
| Treatment | | Pesticide | Pesticide |
| No. | Apron Maxx Fungicide | (Spinosad) | (thiamethoxam) |
| 1 | (metalaxyl: 0.01 mg/seed) | None | None |
| | (fludioxonil: 0.01 mg/seed) | | |
| 2 | (metalaxyl: 0.01 mg/seed) | None | 0.3 mg/seed |
| | (fludioxonil: 0.01 mg/seed) | | |
| 3 | (metalaxyl: 0.01 mg/seed) | 0.2 mg/seed | None |
| | (fludioxonil: 0.01 mg/seed) | | |
| 4 | (metalaxyl: 0.01 mg/seed) | 0.2 mg/seed | 0.3 mg/seed |
| | (fludioxonil: 0.01 mg/seed) | | |

### Example Two

### Application of Seed Treatment Formulation to Seeds

Seeds coated with seed treatment compositions made as set forth in Example One were prepared by mechanically mixing 30 cc of the seed treatment composition in 2 kg of sunflower seeds (Helianthus annuus (L.) SPS 3190) using a Universal Batch seed treater (NIKLAS) to provide accurate and thorough seed coverage. Each of the four seed treatment compositions (i.e., the seed treatment compositions including the proportions of ingredients as set forth in Table 1) was applied to a quantity of viable sunflower seeds in the predetermined amounts.

### Example Three

### Field Tests

The coated sunflower seeds prepared as described in Example Two were planted in a field in Ines Indart, Buenos Aires Province, Argentina. After planting, barriers were installed, each barrier positioned to encircle ten plants of a given treatment group. The barriers are structured to prevent Agrotis larvae (i.e., cutworms) from escaping from the area enclosed by the barriers.

Twenty-one (21) days following planting, the interior of each barrier was infested with four (4) larvae (stage 4) of Agrotis malefida. Following infestation, the number plants cut per group (i.e., within a given barrier) was counted each day for twelve (12) consecutive days. The experimental design was RCBD with 4 replicates. Efficacy of the respective seed treatments was calculated for control of AGROSP on days 3, 5 and 10 after infestation using Abott, to make a Colby interaction analysis. Colby's equation was used to determine the insecticidal effects expected from the mixtures (Colby, S. R. Calculation of the synergistic and antagonistic response of herbicide combinations. Weeds 1967, 15, 20-22).

The following equation was used to calculate the expected activity of mixtures including two active ingredients, A and B:

Expected=A+B−A×B/100)

where A=observed efficacy of active ingredient A at the same concentration as used in the mixture, and B=observed efficacy of active ingredient B at the same concentration as used in the mixture.

Measured efficacy (percent control) data were compared to calculate Colby values. Significant differences (p=0.05) between measured and Colby prediction values indicated that synergy was present.

Compounds tested, application rates employed, plant species tested, and results are given in Table 2.

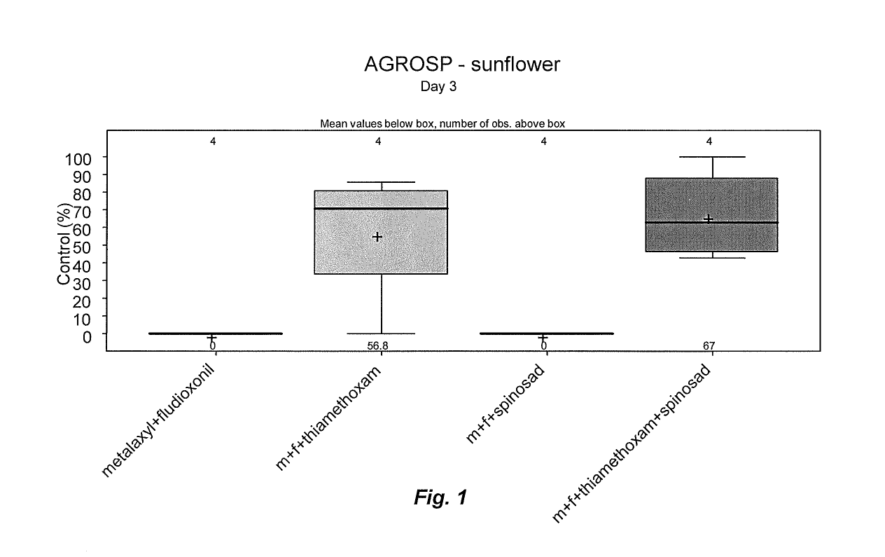

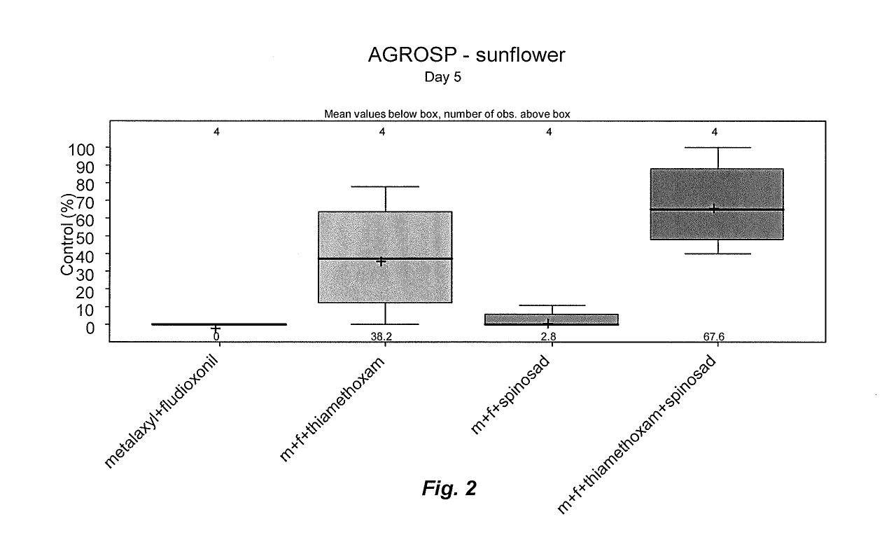

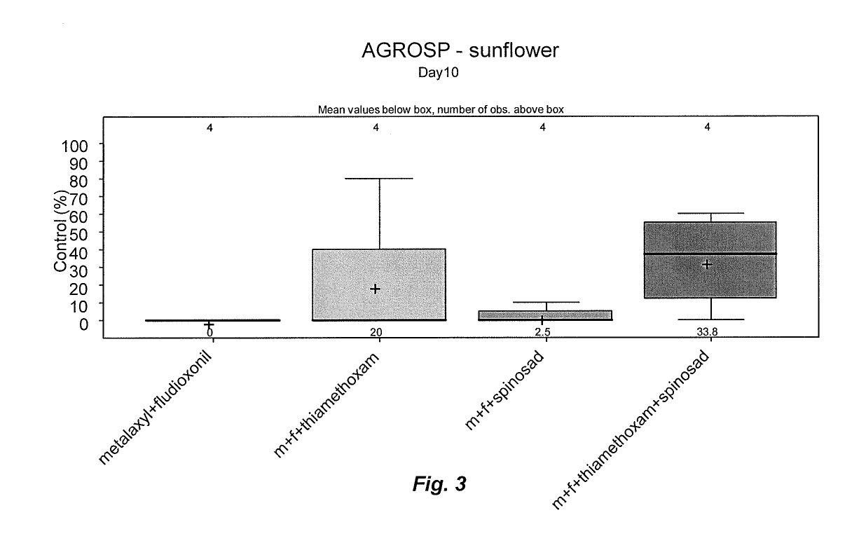

The statistical analysis performed was ANOVA using JMP to compare the efficacy of each seed treatment to control this pest. The data and the calculations for the Colby's analysis are set forth in Table 2 below and the results are depicted graphically in FIGS. 1-3.

TABLE 2

| | Percent | Percent | Percent | Calculated | Ob- |
|---|---|---|---|---|---|
| | control for | control | control | Colby Value | served |
| | ST No. 2 | for ST No. | for ST | (Expected % | vs. |
| | (thiamethoxam | 3 (Spinosad | No. 4 | control if | Ex- |
| | only) | only) | (mixture) | additive) | pected¹ |
| Day | 56.84 | 0 | 66.96 | 56.8 | 10.1 |
| 3 | | | | | |
| Day | 38.19 | 2.78 | 67.64 | 39.9 | 27.7 |
| 5 | | | | | |
| Day | 20 | 2.5 | 33.8 | 22.0 | 11.8 |
| 10 | | | | | |

¹o = additive; positive = synergism; negative = antagonism

These experiments showed that cutworms were active during more than ten (10) days in sunflower, and that the mixture of Spinosad and thiamethoxam were observed to synergistically control the cutworms at a level significantly higher than expected based upon the level of control exerted by the respective compounds individually.

As will be appreciated by a person skilled in the art in view of the above descriptions, in one aspect of the present disclosure, there is provided a method of controlling cutworms, comprising applying to a locus in need of cutworm control a composition comprising a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof.

In another aspect, the present disclosure provides a method comprising applying a synergistic composition comprising a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof to a locus to control cutworms.

In embodiments of the methods described above, the weight ratio of the Spinosyn component to the thiamethoxam component is from about 1:150 to about 75:1. In other embodiments of the above-mentioned methods, the composition further comprises an agriculturally acceptable adjuvant or carrier. In yet other embodiments of the above-mentioned methods, the composition further comprises at least one additional pesticide other than a Spinosyn or thiamethoxam. In still other embodiments of the above-mentioned methods, the composition further comprises at least one other compound having insecticidal, herbicidal, acaricidal, nematicidal or fungicidal activity. In still yet other embodiments, the composition comprises a seed coating and wherein said applying comprises planting a seed coated with said composition. In some embodiments, the Spinosyn comprises Spinosad.

In another aspect of the present disclosure, there is provided a method comprising applying to a viable seed an effective amount of a seed treatment composition comprising a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof. Some embodiments of the method further include allowing the formulation applied to the seed to dry to form a coated seed. In some embodiments, the seed is a seed that has been genetically transformed to express one or more specialized traits. In some embodiments, the seed treatment composition further comprises a binder. In some embodiments, the Spinosyn comprises Spinosad.

In yet another aspect, the disclosure provides an aqueous seed treatment composition that includes: (i) a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof; and (ii) a binder operable to adhere the Spinosyn and the thiamethoxam to a seed. The disclosure also provides a seed treated with a composition set forth above. In certain embodiments, the seed is of a plant selected from the group consisting of sunflower, corn, alfalfa, tomato, tobacco and soybeans. In other embodiments, the seed has a coating thereon comprising the Spinosyn and the thiamethoxam.

While multiple embodiments of the invention have been described in detail in the foregoing description, the same is to be considered as illustrative and not restrictive in character, it being understood that only the selected embodiments have been described and that all changes, modifications and equivalents that come within the spirit of the invention as defined herein or by any of the following claims are desired to be protected. Any theory, mechanism of operation, proof, or finding stated herein is meant to further enhance understanding of the present application and is not intended to make the present application in any way dependent upon such theory, mechanism of operation, proof, or finding. It should be understood that any use of the word preferable, preferably or preferred in the description above indicates that the feature so described may be more desirable, it nonetheless may not be necessary and embodiments lacking the same may be contemplated as within the scope of the invention, that scope being defined by the claims that follow. In reading the claims it is intended that when words such as “a,” “an,” “at least one,” “at least a portion” are used there is no intention to limit the claim to only one item unless specifically stated to the contrary in the claim. Further, when the language “at least a portion” and/or “a portion” is used the item may include a portion and/or the entire item unless specifically stated to the contrary. All patents, patent applications, and publications references herein are hereby incorporated by reference, each in its entirety.

### Acid & Salt Derivatives, and Solvates

The compounds disclosed in this document can be in the form of pesticidally acceptable acid addition salts.

By way of non-limiting example, an amine function can form salts with hydrochloric, hydrobromic, sulfuric, phosphoric, acetic, benzoic, citric, malonic, salicylic, malic, fumaric, oxalic, succinic, tartaric, lactic, gluconic, ascorbic, maleic, aspartic, benzenesulfonic, methanesulfonic, ethanesulfonic, hydroxymethanesulfonic, and hydroxyethanesulfonic, acids.

Additionally, by way of non-limiting example, an acid function can form salts including those derived from alkali or alkaline earth metals and those derived from ammonia and amines. Examples of preferred cations include sodium, potassium, magnesium, and aminium cations.

The salts are prepared by contacting the free base form with a sufficient amount of the desired acid to produce a salt. The free base forms may be regenerated by treating the salt with a suitable dilute aqueous base solution such as dilute aqueous NaOH, potassium carbonate, ammonia, and sodium bicarbonate.

As an example, in many cases, a pesticide is modified to a more water soluble form e.g. 2,4-dichlorophenoxy acetic acid dimethyl amine salt is a more water soluble form of 2,4-dichlorophenoxy acetic acid a well known herbicide.

The compounds disclosed in this document can also form stable complexes with solvent molecules that remain intact after the non-complexed solvent molecules are removed from the compounds. These complexes are often referred to as “solvates”.

### Stereoisomers

Certain compounds disclosed in this document can exist as one or more stereoisomers. The various stereoisomers include geometric isomers, diastereomers, and enantiomers. Thus, the compounds disclosed in this document include racemic mixtures, individual stereoisomers, and optically active mixtures.

It will be appreciated by those skilled in the art that one stereoisomer may be more active than the others. Individual stereoisomers and optically active mixtures may be obtained by selective synthetic procedures, by conventional synthetic procedures using resolved starting materials, or by conventional resolution procedures.

### Formulations

Certain compositions described in this document may also be provided with other phytologically-acceptable inert ingredients to provide or complement a carrier and can be formulated into, for example, baits, fumigants, gels, granules, microencapsulations, suspoemulsions, tablets, and ultra low volume solutions. For further information on formulation types see “CATALOGUE OF PESTICIDE FORMULATION TYPES AND INTERNATIONAL CODING SYSTEM” Technical Monograph no 2, 5th Edition by CropLife International (2002).

The headings in this document are for convenience only and must not be used to interpret any portion thereof.

1. A method of controlling cutworms, comprising applying to a locus in need of cutworm control a composition comprising a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof.

2. A method comprising applying a synergistic composition comprising a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof to a locus to control cutworms.

3. The method in accordance with claim 2 wherein the weight ratio of the Spinosyn component to the thiamethoxam component is from about 1:150 to about 75:1.

4. The method in accordance with claim 2 wherein the composition further comprises an agriculturally acceptable adjuvant or carrier.

5. The method in accordance with claim 2 wherein the composition further comprises at least one additional pesticide other than a Spinosyn or thiamethoxam.

6. The method in accordance with claim 2 wherein the composition further comprises at least one other compound having insecticidal, herbicidal, acaricidal, nematicidal or fungicidal activity.

7. The method in accordance with claim 2 wherein said composition comprises a seed coating and wherein said applying comprises planting a seed coated with said composition.

8. The method in accordance with claim 2 wherein said Spinosyn comprises Spinosad.

9. A method comprising applying to a viable seed an effective amount of a seed treatment composition comprising a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof.

10. The method in accordance with claim 9, further comprising allowing the formulation applied to the seed to dry to form a coated seed.

11. The method in accordance with claim 9 wherein the seed is a seed that has been genetically transformed to express one or more specialized traits.

12. The method in accordance with claim 9 wherein the seed treatment composition further comprises a binder.

13. The method in accordance with claim 9 wherein said Spinosyn comprises Spinosad.

14. An aqueous seed treatment composition comprising:
a synergistic pesticide mixture, the mixture comprising a pesticidally effective amount of (a) a Spinosyn component comprising a member selected from the group consisting of a Spinosyn and agriculturally acceptable salts thereof, and (b) a thiamethoxam component comprising a member selected from the group consisting of thiamethoxam and agriculturally acceptable salts thereof; and
a binder operable to adhere the Spinosyn and the thiamethoxam to a seed.

15. A seed treated with a composition in accordance with claim 14.

16. The seed in accordance with claim 15 wherein the seed is of a plant selected from the group consisting of sunflower, corn, alfalfa, tomato, tobacco and soybeans.

17. The seed in accordance with claim 15 wherein the seed has a coating thereon comprising the Spinosyn and the thiamethoxam.

18. The method in accordance with claim 1 wherein the weight ratio of the Spinosyn component to the thiamethoxam component is from about 1:150 to about 75:1.

19. The method in accordance with claim 1 wherein the composition further comprises at least one other compound having insecticidal, herbicidal, acaricidal, nematicidal or fungicidal activity.

20. The method in accordance with claim 1 wherein said Spinosyn comprises Spinosad.
